(19) United States
(12) Patent Application Publication
(10) Pub. No.: US 2009/0173193 A1
(43) Pub. Date: Jul. 9, 2009

(54) Torque tool aid for achieving higher bolt torques

(75) Inventors: E. Russ Althof, Tucson, AZ (US); Donald J. Redmon, Tucson, AZ (US); Bradley E. Bergmann, Tucson, AZ (US)

Correspondence Address: Benman, Brown & Williams, Suite 2740, 2049 Century Park East, Los Angeles, CA, 90067, US

(73) Assignee: RAYTHEON COMPANY

(21) Appl. No.: 12/008,026

(22) Filed: Jan. 8, 2008

(51) Int. Cl. B25B 23/08

(52) U.S. Cl. 81/451

(57) ABSTRACT

A device for securing a torque bit to a fastener in an object. The novel device includes a structure adapted to apply a force on the torque bit and a mechanism for clamping the structure to the object such that the structure forces the bit to remain engaged with a drive feature of the fastener. In an illustrative embodiment, the structure is bolted to the object, capturing the bit between the structure and the object. Spacers disposed between the structure and the object control the magnitude of the force applied on the bit such that the bit can rotate during torquing. In an alternative embodiment, the structure surrounds the object and is tightened to clamp the structure to the object. An insert disposed between the structure and the bit controls the magnitude of the force applied on the bit in this embodiment.

### BACKGROUND OF THE INVENTION

1. Field of the Invention

The present invention relates to torque tools. More specifically, the present invention relates to systems and methods for applying torque to structural fasteners.

2. Description off the Related Art

Structural fasteners are commonly used to mechanically join two or more objects or parts of an object together. A bolted joint, for example, includes a bolt or cap screw that joins the objects and is secured with a mating thread (on a nut or on one of the objects being joined). The bolt is tightened to a calculated torque, producing a particular preload (the tension in the bolt caused by tightening). Generating sufficient preload is essential for providing a strong and reliable bolted joint that will not loosen or break. The greater the preload (up to the fastener's maximum preload capability), the greater the strength of the joint.

It is therefore critical to apply enough torque to set the bolt to the desired preload. Some structural fasteners, however, cannot be pre-loaded to their maximum capability because it is difficult to achieve high levels of torques due to slippage or stripping of the torque interface and torque tools (i.e., torque wrenches and torque bits).

A higher preload can be achieved by using a larger bolt or a fastener with a drive feature designed for higher torque levels. For example, a hex head drive feature with a protruding hexagonal head can typically sustain more torque than a recessed cross feature (such as a Phillips head). In certain applications, however, it may not be feasible or desirable to use a larger bolt or a bolt with a higher torque drive feature due to various size or design constraints. For example, in the aerospace industry, bolts on an airframe typically need to be flush with the airframe to reduce aerodynamic effects such as drag. Flat-head bolts with a recessed cross drive are therefore typically used in these applications instead of hex head bolts.

High strength, flat-head bolts are capable of sustaining the high preloads desired in these applications. However, it is difficult to tighten the bolts to the desired preloads using conventional techniques. The resulting preload is usually as low as 50% of the fastener's capability due to the limited amount of torque that can be applied before the torque tool slips or the drive feature strips. Typically, more “force” by the operator is used to try to keep the torque tool engaged in the fastener drive. But if the tool or drive is worn, it is difficult to achieve even 50% of the desired capability, much less more than that.

Hence, a need exists in the art for an improved system or method for tightening a fastener that can achieve higher levels of torque than prior approaches.

### SUMMARY OF THE INVENTION

The need in the art is addressed by the torque tool aid of the present invention. The novel torque tool aid is a device for securing a torque bit to a fastener in an object. The device includes a structure adapted to apply a force on the torque bit and a mechanism for clamping the structure to the object such that the structure forces the bit to remain engaged with a drive feature of the fastener. In an illustrative embodiment, the structure is bolted to the object, capturing the bit between the structure and the object. Spacers disposed between the structure and the object control the magnitude of the force applied on the bit such that the bit can rotate during torquing. In an alternative embodiment, the structure surrounds the object and is tightened to clamp the structure to the object. An insert disposed between the structure and the bit controls the magnitude of the force applied on the bit in this embodiment.

### BRIEF DESCRIPTION OF THE DRAWINGS

FIG. 1a is a simplified schematic of an illustrative drive feature on a fastener.

FIG. 1b is a simplified schematic of an illustrative torque set bit for applying torque to the fastener of FIG. 1a.

FIG. 2 is a simplified diagram of a torque tool aid device designed in accordance with an illustrative embodiment of the present teachings.

FIG. 3 is a simplified diagram of a torque tool aid device designed in accordance with an illustrative embodiment of the present teachings.

FIG. 4 is a three-dimensional view of the illustrative torque tool aid device shown in FIG. 3.

FIG. 5a is a simplified diagram of a torque tool aid device designed in accordance with an alternative embodiment of the present teachings.

FIG. 5b is a diagram showing a close up view of part of the torque tool aid device shown in FIG. 5a.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention uses a novel device for securing the torque tool in the fastener drive head during torquing. This eliminates the need for the operator to force the torque tool into the drive and allows more effort towards achieving the desired preload. By securing the torque tool into the drive without the additional need of operator force, much higher torques may be achieved without slippage or stripping.

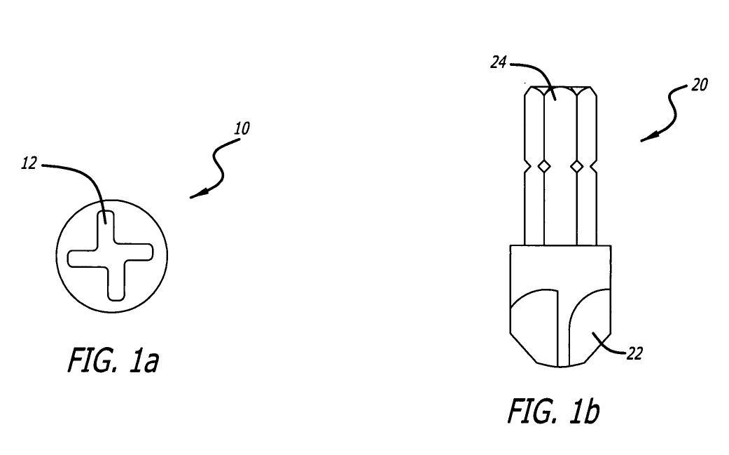

FIG. 1a is a simplified schematic of an illustrative drive feature 12 on a fastener 10. FIG. 1b is a simplified schematic of an illustrative torque set bit 20 for applying torque to the fastener 10 of FIG. 1a. The fastener 10 has a particular drive feature 12 in the head of the fastener 10. The torque bit 20 has a first end or bit head 22 that is shaped so that it engages the drive feature 12 of the fastener 10. The other end 24 of the torque bit 20 is attached to a torque wrench or other torque tool (not shown). Turning the torque wrench turns the torque bit 20, which turns the fastener 10 as long as the bit 20 remains engaged with the drive feature 12.

The illustrative drive feature 12 shown in FIG. 1a is a cross-recessed cruciform drive 12 commonly used in the aerospace industry. The present invention may also be applied to other types of drives and fasteners without departing from the scope of the present teachings.

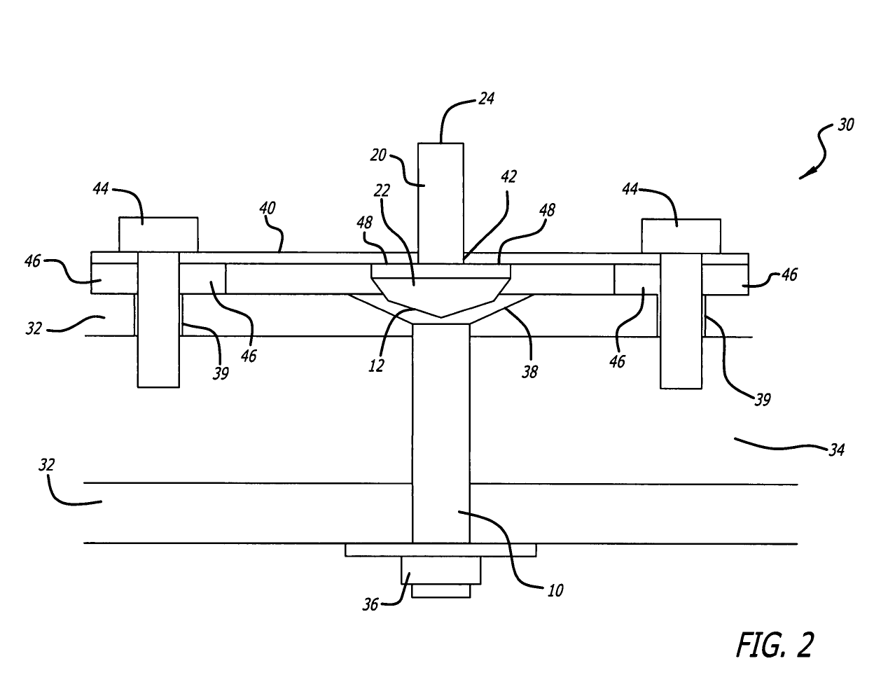

FIG. 2 is a simplified diagram of a torque tool aid device 30 designed in accordance with an illustrative embodiment of the present teachings. The novel torque tool aid 30 is adapted to retain a torque bit 20 in the drive feature 12 of a fastener 10, allowing an operator to tighten the fastener 10 by rotating a torque tool coupled to the torque bit 20 without needing to apply additional force to keep the bit 20 engaged with the fastener 10. This allows the fastener 10 to be tightened to a higher torque—and therefore a higher preload—than can be achieved using conventional techniques.

In the illustrative embodiment of FIG. 2, the fastener 10 joins two parts (for example, a missile airframe 32 and a payload component 34) and is secured by a nut plate 36. In this example, the fastener 10 is a flat-head bolt with a cross-recessed cruciform drive 12, as shown in FIG. 1a. The head of the fastener 10 sits in a countersink 38 in the airframe 32 so that the fastener 10 is flush with or below the surface of the airframe 32.

In accordance with the present teachings, the novel torque tool aid 30 includes a bit retaining plate 40 or other structure adapted to hold the torque bit 20 in place, engaged with the drive feature 12 of the fastener 10. In the illustrative embodiment, the plate 40 has a hole 42 through which the torque bit 20 is inserted so that the bit head 22 is on one side of the plate 40 (toward the fastener 10) while the second end 24 of the bit 20 (that couples to the torque wrench) is on the opposite side of the plate 40. The bit head 22 has a circumference that is larger than the rest of the torque bit 20, such that when the bit 20 is inserted in the hole 42, the plate 40 rests against the bit head 22.

The torque tool aid 30 is attached to the airframe 32 so that the torque bit 20 is trapped between the plate 40 and the airframe 32, and the plate 40 applies a predetermined force on the bit 20, forcing the bit 20 into the drive feature 12 of the fastener 10. In the embodiment of FIG. 2, the torque tool aid 30 is attached to the airframe 32 by two bolts 44 on either side of the torque bit 20. The bolts 44 may be screwed into holes drilled into the airframe 32 specifically for this purpose, or in the preferred embodiment, the torque tool aid 30 may be designed so that the bolts 44 are screwed into holes 39 already existing in the airframe 32 (for fastening other components, for example).

The torque tool aid 30 also includes a spacer 46 around each bolt 44, between the plate 40 and the airframe 32, for controlling the amount of force the plate 40 applies to the bit 20 so that the bit 20 can rotate. If too much force is applied to the bit 20, the friction between the plate 40 and the bit head 22 may be too high to torque the bit 20. If not enough force is applied to the bit 20, the bit 20 may slip out of the drive feature 12 of the fastener 10. The thickness of the spacers 46 (i.e., the distance between the plate 40 and the surface of the airframe 32) should therefore be sized such that the bit 20 remains engaged in the fastener drive 12, while also allowing the bit 20 to rotate without too much friction against the plate 40.

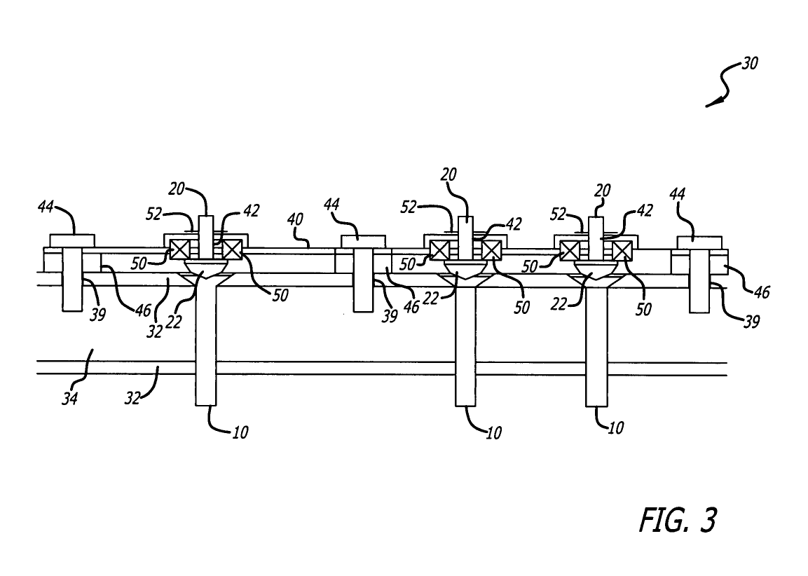

Optionally, an anti-friction coating 48 may be applied to the plate 40 where the plate 40 is in contact with the bit head 22, or a bearing 50 (shown in FIG. 3) may be placed between the plate 40 and the bit 20 to reduce friction.

The bit retaining plate 40 should be made from an appropriate material and sized properly so that the torque bit 20 will remain engaged with the drive feature 12 of the fastener 10 while placing as much torque as is desired onto the fastener 10. Specifically, the plate 40 should be stiff enough to prevent flexure based on the estimated load associated with the desired torque. Otherwise, if the plate 40 flexes or bends during torquing, the bit 20 may ride out of the drive feature 12. In an illustrative embodiment, the plate 40 is made from metal or plastic. The spacers 46 may be made from the same material as the plate 40, or from a different material.

In the embodiment of FIG. 2, the torque tool device 30 is adapted to retain only one torque bit 20. The device 30 may also be designed to retain several bits 20 simultaneously to simplify installation and use, depending on the application. FIG. 3 illustrates how the torque tool aid of the present invention might be customized for a particular illustrative application.

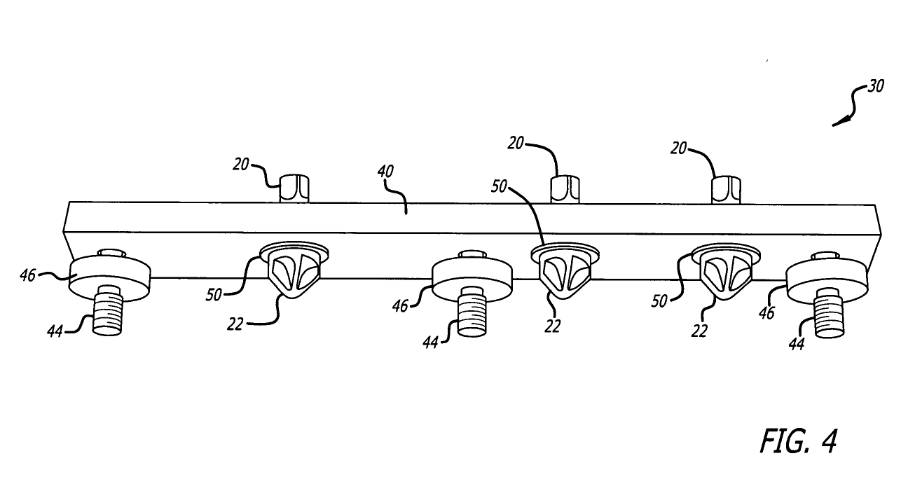

FIG. 3 is a simplified diagram of a torque tool aid device 30 designed in accordance with an illustrative embodiment of the present teachings. FIG. 4 is a three-dimensional view of the illustrative torque tool aid device 30 shown in FIG. 3. In this example, three payload bolts 10 joining an airframe 32 and a payload component 34 need to be tightened to a torque of about 200 in-lbs to prevent joint slippage (numerical examples are given for illustrative purposes only). The payload bolts 10 have a capability of about 260 in-lbs, but can only be tightened to 125 in-lbs using just a torque wrench without the torque tool aid 30. The airframe 32 also includes three bolt holes 39 near the payload bolts 10, for attaching other components to the airframe 32.

In accordance with the present teachings, a torque tool aid 30 is customized for this example application by designing a bit retaining plate 40 that attaches to the airframe 32 using attach bolts 44 that screw into the bolt holes 39. The bit retaining plate 40 includes three holes 42 for holding three torque bits 20. The torque tool aid 30 may also include a bearing 50 placed around each torque bit 20, between the bit head 22 and the bit retaining plate 40, for reducing friction. In the embodiment of FIG. 3, a clip 52 is placed around each bit 20, on the side of the plate 40 opposite the bit head 22, to prevent the bits 20 from falling out of the plate 40.

In a preferred embodiment, the attach bolts 44 are socket head cap screws with a drive feature matching that of the payload bolts 10 so that a common torque tool can be used to install the torque tool aid device 30 and to tighten the payload bolts 10.

In operation, the payload component 34 is joined to the airframe 32 and the three payload bolts 10 are tightened using a torque wrench (to about 125 in-lbs). The torque tool aid 30 is then attached to the airframe 32 by the attach bolts 44, with the three torque bits 20 captured between the bit retaining plate 40 and the airframe 32 such that the bits 20 are engaged with the drive features 12 of the fasteners 10. The torque wrench is then coupled to each torque bit 20, and the payload bolts 10 are torqued to the desired torque. The torque tool aid 30 and torque bits 20 are then removed, leaving the airframe bolt holes 39 free for their original purpose.

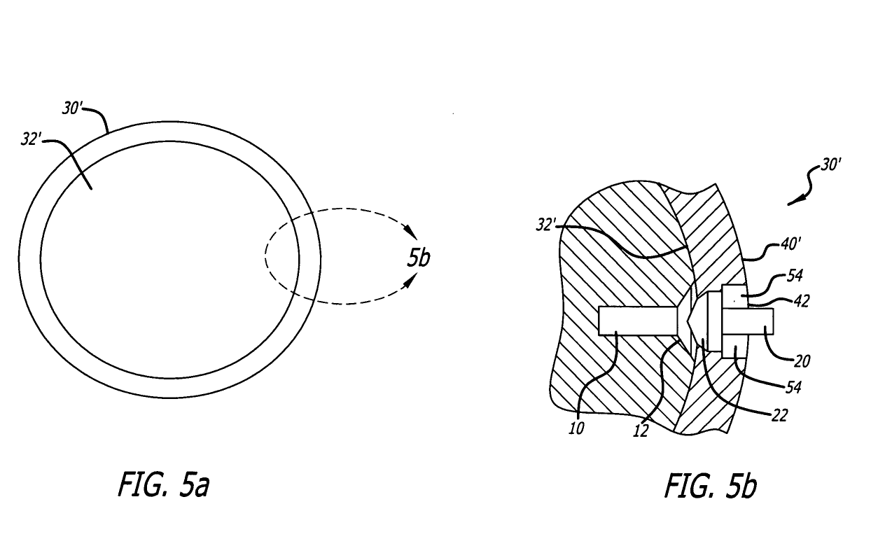

FIG. 5a is a simplified diagram of a torque tool aid device 30′ designed in accordance with an alternative embodiment of the present teachings. In this embodiment, the torque tool aid 30′ is shaped so that it slides over and around the components being fastened, instead of being bolted to one of the components as in the embodiments of FIGS. 2-4. In the example shown in FIG. 5, the fasteners 10 are in a round missile airframe 32′, and the torque tool aid 30′ is a ring that fits around the missile body 32′.

FIG. 5b is a diagram showing a close up view of part of the torque tool aid device 30′ of FIG. 5a. The torque tool aid 30′ includes a bit retaining plate 40′, which in this embodiment is shaped as a ring that goes around the circumference of the missile airframe 32′. The bit retaining ring 40′ includes a hole or cutout 42 through which the torque bit 20 is inserted such that the ring 40′ holds the bit 20 engaged with the drive feature 12 of the fastener 10. Instead of being clamped to the airframe 32′ by bolts, the ring 40′ is tightened around the missile body 32′, such that the bit 20 is held in place by the ring 40′ using the force from the opposite side of the ring 40′. The ring 40′ may also include a mechanism (not shown) for tightening and loosening the ring 40′.

An insert 54 is attached to the ring 40′ between the bit head 22 and the ring 40′. The insert 54 serves a similar purpose as the spacer 46 in the previous embodiments, controlling the amount of force placed on the bit 20 to retain the bit 20 in the fastener drive 12 while allowing the bit 20 to rotate without too much friction. In an illustrative embodiment, the insert 54 is threaded, allowing it to be screwed into the ring 40′. The insert 54 may be fabricated from a material or coated with a material designed to reduce friction at the bit-insert interface during torquing. The torque tool aid 30′ may also include a bearing placed between the bit 20 and the insert 54 to reduce friction.

The ring 40′ may include holes or cut-outs 42 at multiple locations to simultaneously hold multiple torque bits 20 (to easily tighten multiple fasteners, as in the embodiments of FIG. 3-4), or it may be adapted to hold just one torque bit 20, in which case after one fastener is torqued, the ring 40′ would be loosened, rotated to place the bit 20 on the next fastener, and re-tightened, allowing the next fastener to be torqued. The torque tool aid 30′ may also be designed to fit any shape, not just a round ring.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A device for securing a torque bit to a fastener in an object, said device comprising:
a structure adapted to apply a force on said torque bit, wherein said bit is adapted to apply a torque to said fastener;
first means for clamping said structure to said object such that said structure forces said bit to remain engaged with said fastener; and
second means for reducing friction between said structure and said bit during torquing.

2. (canceled)

3. The invention of claim 1 wherein said structure includes an opening through which a first end of said bit is inserted.

4. The invention of claim 3 wherein said structure is adapted to hold said bit such that said first end of said bit is on a first side of said structure and a second end of said bit is on a second side of said structure.

5. The invention of claim 4 wherein said second end of said bit includes a bit head that is adapted to engage with a drive feature of said fastener.

6. The invention of claim 5 wherein said structure applies said force on said bit head.

7. The invention of claim 6 wherein said first end of said bit is coupled to a torque tool.

8. The invention of claim 4 wherein said device further includes third means for holding said bit in place during handling.

9. The invention of claim 8 wherein said third means includes a clip placed on said first end of said bit.

10. (canceled)

11. The invention of claim 1 wherein said second means includes an anti-friction coating on said structure.

12. The invention of claim 1 wherein said second means includes a bearing disposed between said structure and said bit.

13. The invention of claim 1 wherein said structure has a stiffness adapted to prevent flexure during torquing.

14. The invention of claim 1 wherein said bit is captured between said structure and said object.

15. The invention of claim 1 wherein said first means includes a plurality of bolts adapted to bolt said structure to said object.

16. The invention of claim 15 wherein said bolts are bolted to pre-existing bolt holes in said object.

17. The invention of claim 15 wherein said device further includes fourth means for controlling a magnitude of said force applied on said torque bit.

18. The invention of claim 17 wherein said fourth means includes one or more spacers between said structure and said object.

19. The invention of claim 18 wherein said spacers are adapted to control a distance between said structure and said object such that said bit remains engaged with said fastener and said bit can rotate.

20. The invention of claim 19 wherein said spacers are disposed around said bolts.

21. A device for securing a torque bit to a fastener in an object, said device comprising:
a structure adapted to apply a force on said torque bit, wherein said structure surrounds said object; and
first means for clamping said structure to said object such that said structure forces said bit to remain engaged with said fastener.

22. The invention of claim 21 wherein said first means includes means for tightening said structure around said object.

23. The invention of claim 21 wherein said device further includes an insert disposed between said structure and said bit for controlling a magnitude of said force applied on said torque bit.

24. The invention of claim 23 wherein said insert is attached to said structure.

25. The invention of claim 21 wherein said structure is a ring.

26. The invention of claim 1 wherein said structure is a plate.

27. The invention of claim I wherein said fastener is a bolt.

28. The invention of claim 1 wherein said structure is adapted to apply a force on one or more additional torque bits such that each additional bit remains engaged with a corresponding fastener in said object.

29. A device for securing a torque bit to a fastener in an object, said device comprising:
a structure adapted to hold said torque bit such that a first end of said bit is on a first side of said structure and a second end of said bit is on a second side of said structure, said first end being coupled to a torque tool and said second end including a bit head engaged with a drive feature of said fastener;
a plurality of bolts bolting said structure to said object such that said bit is captured between said structure and said object, and said structure forces said bit to remain engaged with said drive feature of said fastener; and
one or more spacers disposed around said bolts between said structure and said object to control a distance between said structure and said object such that said bit remains engaged with said fastener and said bit can rotate when said torque tool applies a torque to said bit.

30. A device for securing a torque bit to a fastener in an object, said device comprising:
a structure surrounding said object and adapted to hold said torque bit such that a first end of said bit is on a first side of said structure and a second end of said bit is on a second side of said structure, said first end being coupled to a torque tool and said second end including a bit head engaged with a drive feature of said fastener,
a mechanism for tightening said structure around said object such that said structure is clamped to said object and applies a force on said bit, causing the bit to remain engaged with said drive feature of said fastener; and
an insert disposed between said structure and said bit for controlling a magnitude of said force applied on said torque bit such that said bit remains engaged with said fastener and said bit can rotate when said torque tool applies a torque to said bit.

31. A method for applying torque to a fastener in an object including the steps of:
inserting a torque bit in a structure adapted to apply a force on said bit, wherein said bit is adapted to apply a torque to said fastener;
applying a mechanism to said structure for reducing friction between said structure and said bit during torquing:
clamping said structure to said object such that said bit is captured between said structure and said object and said structure forces said bit to remain engaged with a drive feature of said fastener;
coupling a torque tool to said bit; and
rotating said bit with said torque tool to apply a torque to said fastener.

32. The invention of claim 1 wherein said first means includes means for securing said structure to said object on opposite sides of said torque bit.

33. The invention of claim 32 wherein said first means includes at least two fastening devices for securing said structure to said object, at least one fastening device on either side of said torque bit.
